(19) United States
(12) Patent Application Publication
(10) Pub. No.: US 2023/0334989 A1
(43) Pub. Date: Oct. 19, 2023

(54) SLIPSTREAM DRIVING ARRANGEMENT SYSTEMS AND METHODS

(71) Applicant: Ford Global Technologies, LLC, Dearborn, MI (US)

(72) Inventors: Justin Campanaro, Ferndale, MI (US); William Hartnagel, Northville, MI (US); Anthony Melatti, Canton, MI (US); Barry Shepherd, Berkley, MI (US); Katherine Howard-Cone, Canton, MI (US)

(73) Assignee: Ford Global Technologies, LLC, Dearborn, MI (US)

(21) Appl. No.: 17/659,824

(22) Filed: Apr. 19, 2022

(51) Int. Cl. G08G 1/00; B60W 30/14; G06Q 30/02

(52) U.S. Cl. CPC G08G 1/22; B60W 30/143; G06Q 30/0208; B60W 2556/65

(57) ABSTRACT

Example embodiments described in this disclosure are generally directed to systems and methods to form a caravan of vehicles and take advantage of a slipstream formation that can provide benefits such as, for example, a reduction in fuel consumption for follower vehicles. In an example method, a first vehicle transmits a request to form a caravan with a second vehicle. The request may be originated by a slipstream driving arrangement system that can be a part of the first vehicle or provided in a personal communication device of a driver of the first vehicle. Upon receiving an acceptance of the request from a second vehicle, the first vehicle may execute a rendezvous operation to rendezvous with the second vehicle and execute a slipstream formation with the second vehicle. A financial incentive may be offered to either vehicle for operating as a lead vehicle of the caravan.

### BACKGROUND

Vehicle manufacturers as well as vehicle drivers generally seek to obtain cost benefits associated with maximizing vehicle driving range per gallon of fuel (or, in the case of battery electric vehicles, optimize battery energy consumption).

In order to do so, a vehicle manufacturer may improve an efficiency of a gasoline engine, or, in the case of a battery electric vehicle, may design the vehicle to have minimum weight and to include a higher capacity battery. A vehicle driver may seek to reduce gasoline costs by operating the vehicle at certain speeds and by performing maintenance operations to ensure that the engine is running optimally. Such approaches tend to provide benefits and it is therefore desirable to provide additional solutions that provide these benefits.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example vehicle that includes a slipstream driving arrangement system in accordance with an embodiment of the disclosure.

FIG. 2 shows a graph that illustrates a relationship between vehicle speed and road load.

FIG. 3 shows an example scenario where one vehicle communicates with another vehicle to request forming of a caravan in accordance with the disclosure.

FIG. 4 shows an example scenario involving vehicles moving in a slipstream driving arrangement in accordance with the disclosure.

FIG. 5 shows some example components that may be included in a vehicle in accordance with the disclosure.

FIG. 6 shows a flowchart of an example method to execute a slipstream driving arrangement in accordance with the disclosure.

### DETAILED DESCRIPTION

### Overview

In terms of a general overview, certain embodiments described in this disclosure are directed to systems and methods related to forming a caravan of vehicles and take advantage of a slipstream formation that can provide various benefits such as, for example, a reduction in fuel consumption for follower vehicles.

In an example method, a first vehicle transmits a request to form a caravan with a second vehicle. The request may be originated by a slipstream driving arrangement system that can be a part of the first vehicle, or provided in a personal communication device of a driver of the first vehicle. The second vehicle may accept the request. Upon receiving the acceptance of the request from the second vehicle, the first vehicle may execute a rendezvous operation to rendezvous with the second vehicle and execute a slipstream formation with the second vehicle. A financial incentive may be offered to the first vehicle or to the second vehicle to encourage operating as a lead vehicle of the caravan.

In another example method, a first vehicle broadcasts an offer to operate as a lead vehicle (or as a follower vehicle) in a slipstream driving arrangement. A second vehicle may accept the offer. The first vehicle may then rendezvous with the second vehicle to execute a slipstream formation. Rendezvousing with the second vehicle can involve the first vehicle and/or the second vehicle speeding up and/or slowing down on a road shared by the two vehicles.

### ILLUSTRATIVE EMBODIMENTS

The disclosure will be described more fully hereinafter with reference to the accompanying drawings, in which example embodiments of the disclosure are shown. This disclosure may, however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, the word “vehicle” as used herein refers to any type of vehicle that produces a slipstream and/or can benefit from traveling in a slipstreaming formation. A few example vehicles can include a gasoline powered vehicle, an electric vehicle, a hybrid electric vehicle, an autonomous vehicle, a sedan, a sports utility vehicle (SUV), a semi-tractor trailer (18-wheeler), a delivery truck, and a van. The word “caravan” as used herein refers to two or more vehicles that travel one behind the other in formation. A caravan can be a part of a convoy. The term caravan includes platooning.

It must be understood that the description provided herein, particularly, with reference to actions performed by the driver of a vehicle, can be performed by a computer of an autonomous vehicle. Thus, for example, description provided herein with reference to a request originated by a driver for forming a caravan with one or more other vehicles may be originated by the computer of an autonomous vehicle and automatically transmitted via wireless communications to the other vehicles. Furthermore, it must be understood that phrases such as, for example, “transmitting, by a first vehicle” and “executing, by a first vehicle” as used herein can be actions performed by a driver of a vehicle (when the vehicle is operated by a driver) ort actions performed by a computer (when the vehicle is an autonomous vehicle and in some cases when operated by a driver).

Words such as “slipstream” or “slipstreaming” as used herein generally refers to a driving practice where a follower vehicle takes advantage of a low-pressure area (or “wake”) created by a lead vehicle in order to conserve fuel and gain other benefits associated with reducing “drag” or “air resistance.” Alternative words such as “drafting” may be used in lieu of “slipstreaming” in some cases.

It must also be understood that words such as “implementation,” “scenario,” “case,” “configuration,” “instance,” and “situation” as used herein are an abbreviated version of the phrase “In an example (“implementation,” “scenario,” “case,” “configuration,” “approach,” “instance,” and “situation”) in accordance with the disclosure.” Furthermore, the word “example” as used herein is intended to be non-exclusionary and non-limiting in nature.

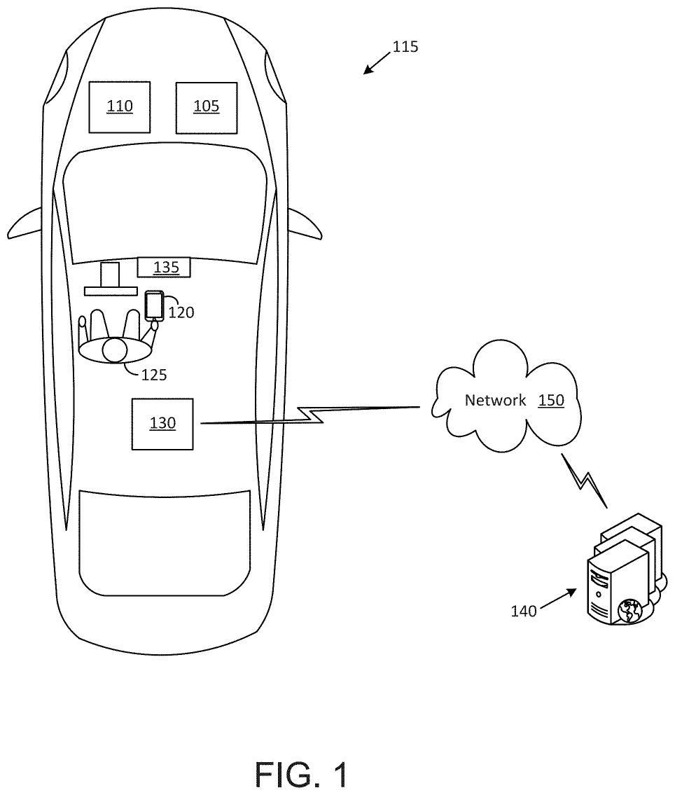

FIG. 1 shows an example vehicle 115 that includes a slipstream driving arrangement system 105 in accordance with an embodiment of the disclosure. The vehicle 115 may also include components such as a vehicle computer 110 (e.g., a vehicle controller or the like), an infotainment system 135, and a communication system 130. The vehicle computer 110 may perform various functions such as controlling engine operations (fuel injection, speed control, emissions control, braking, etc.), managing climate controls (air conditioning, heating etc.), activating airbags, and issuing warnings (check engine light, bulb failure, low tire pressure, vehicle in blind spot, etc.). In some cases, the vehicle computer 110 may include more than one computer such as, for example, a first computer that controls engine operations and a second computer that operates the infotainment system 135.

The infotainment system 135 can be an integrated unit that includes various components such as a radio, a CD player, a video player, and a navigation system. In an example implementation, the infotainment system 135 has a display system that includes a graphical user interface (GUI) for use by an occupant of the vehicle 115. The GUI may be used by the driver for various purposes such as to input a request to form a caravan with one or more other vehicles, and to obtain information about a slipstream driving arrangement. The information can include, for example, rendezvous time information, rendezvous location information, driving directions to rendezvous, navigation assistance, incentives, etc.

A driver 125 of the vehicle 115 may operate a personal communication device 120 for various purposes such as, for example to conduct telephone conversations, to exchange text messages and/or emails, to capture images (photos, videos, etc.), and to interact with the slipstream driving arrangement system 105. The personal communication device 120 can be any of various devices such as, for example, as a smartphone, a tablet computer, a laptop computer, or a wearable device (smartwatch, for example).

In an embodiment in accordance with the disclosure, a software application may be downloaded into the personal communication device 120 for executing various operations in accordance with the disclosure. Some or all of the operations and features of the software application can be identical to, or substantially similar to, operations described herein with reference to the slipstream driving arrangement system 105 provided in the vehicle 115. In one example implementation, the software application provided in the personal communication device 120 may be used in lieu of, or in cooperation with, the slipstream driving arrangement system 105 provided in the vehicle 115.

The slipstream driving arrangement system 105 may be configured to interact with various components in the vehicle 115 such as the vehicle computer 110, the infotainment system 135, and the personal communication device 120. More particularly, the slipstream driving arrangement system 105 may interact with the vehicle computer 110 to control various operations of the vehicle 115 (such as, for example, varying a speed of movement of the vehicle 115) when traveling to a rendezvous location with another vehicle for forming a slipstream formation.

As another example, the slipstream driving arrangement system 105 may interact with the infotainment system 135 and/or the personal communication device 120 and/or the communication system 130 for executing various operations associated with a slipstream driving arrangement in accordance with the disclosure.

In the example embodiment shown in FIG. 1, the slipstream driving arrangement system 105 is communicatively coupled to a computer 140 via a network 150. The computer 140 can be a server computer that is configured to execute functions such as, for example, administrative functions associated with slipstreaming driving arrangements in accordance with the disclosure. The network 150 may include any one, or a combination of networks, such as a local area network (LAN), a wide area network (WAN), a telephone network, a cellular network, a cable network, a wireless network, and/or private/public networks such as the Internet. The network 150 may support various types of communications such as, for example, Internet protocol communications (TCP/IP, for example), cellular communications, Wi-Fi, Wi-Fi direct, machine-to-machine communication, and/or man-to-machine communication. At least one portion of the network 150 includes a wireless communication link that allows the communication system 130 to wirelessly communicate with the computer 140.

The communication system 130 is configured to employ wired and/or wireless communication technologies such as, for example, Bluetooth, cellular, and near-field communication (NFC) to communicate with devices present inside the vehicle 115 or brought into the vehicle 115 (such as, for example, the personal communication device 120).

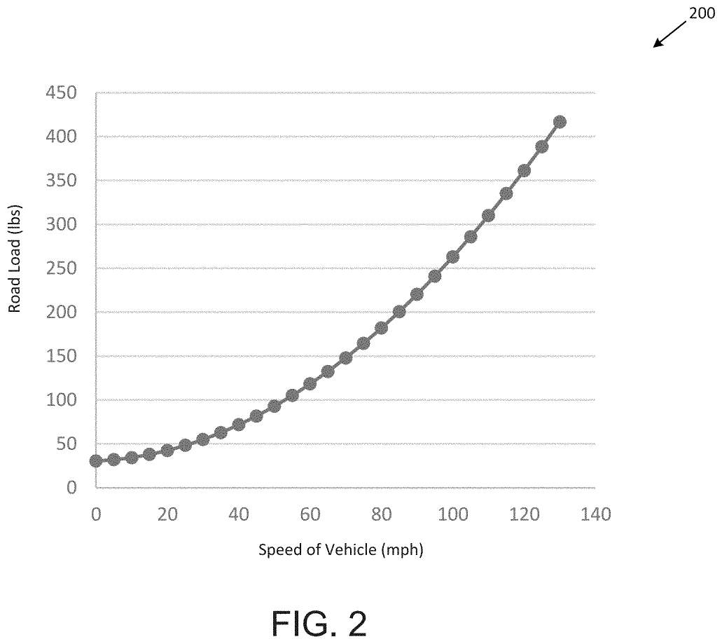

FIG. 2 shows a graph 200 that illustrates a relationship between vehicle speed and road load. Road load generally refers to any of various forms of resistance to the movement of a vehicle, including, for example, air resistance and road surface contact resistance. A vehicle that has a large profile (particularly in a front end) has higher road load. The road load increases quadratically as the speed of the vehicle increases. The increase can be a quadratic increase in one case and an exponential increase in another case.

However, a vehicle having a large profile (such as, for example, a bus, a truck, or a van) creates a larger low-pressure area in a wake of the vehicle in comparison to a low-pressure area created by a smaller and more streamlined vehicle (such as, for example, a compact passenger car or a sports car). The larger low-pressure area behind the moving vehicle may be used advantageously by another vehicle that is slipstreaming the larger vehicle.

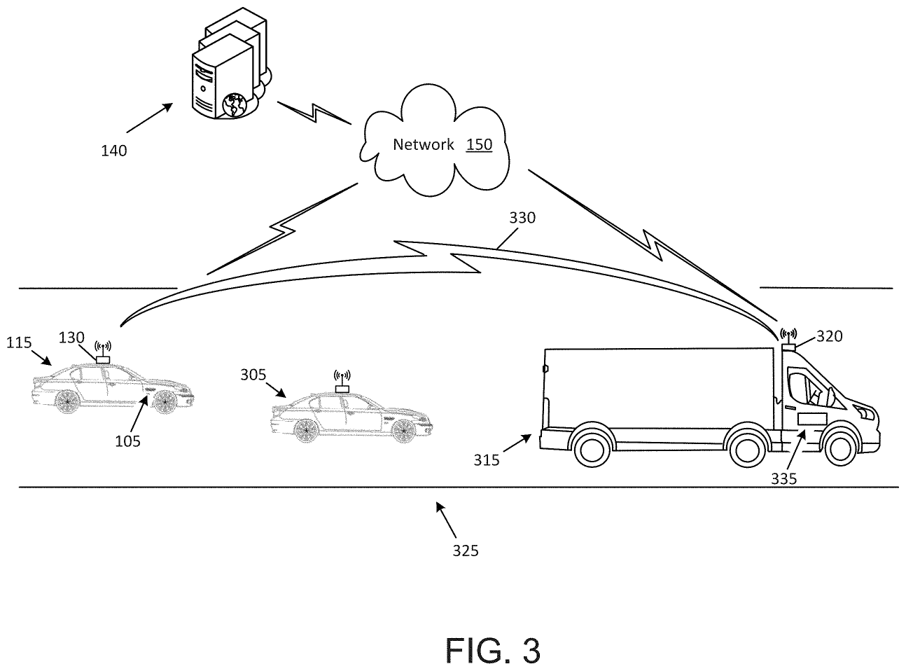

FIG. 3 shows an example scenario where one vehicle (the vehicle 115, for example) communicates with another vehicle (the vehicle 315, for example) to request forming of a caravan in accordance with the disclosure. In this example scenario, the vehicle 115 and the vehicle 315 are traveling on a road 325. The road 325 can be any of various types of roads such as, for example, a one-way single lane road, a two-way single lane road, or a multi-lane road. A vehicle 305 is traveling between the vehicle 115 and the vehicle 315 on the road 325.

The vehicle 305 and the vehicle 315 can be any of various types of vehicles. In this example, the vehicle 315 is a semi-tractor-trailer truck (an 18-wheeler) that has a large road load and produces a large low-pressure area in its wake when moving on the road 325. A driver of the vehicle 115 may desire to take advantage of the low-pressure area.

In a first example embodiment, the slipstream driving arrangement system 105 may transmit to the computer 140, a request for forming a caravan with the vehicle 315 operating as a lead vehicle of the caravan. The request may be transmitted in the form of a wireless signal from the communication system 130 of the vehicle 115. The wireless signal may be conveyed from the vehicle 115 to the computer 140 in various ways such as, for example, via the network 150 or via a vehicle-to-infrastructure (V2I) apparatus (not shown).

In one case, the computer 140 may receive the request from the vehicle 115, record the request (for subsequent administration purposes), and relay the request to a slipstream driving arrangement system 335 provided in the vehicle 315. The slipstream driving arrangement system 335 may receive the request (in the form of a wireless signal) via a communication system 320 of the vehicle 315.

The slipstream driving arrangement system 335 may then display the request to a driver of the vehicle 315. The request may be displayed, for example, in the form of a message upon a display screen of an infotainment system (not shown) of the vehicle 315 and/or on a personal communication device of the driver of the vehicle 315. The driver of the vehicle 315 may either accept the request or may turn down the request. In an example implementation, the driver of the vehicle 315 may be incentivized to accept the request. Details pertaining to incentivizing are provided below.

If the driver of the vehicle 315 accepts the request, the slipstream driving arrangement system 335 of the vehicle 315 sends an acceptance message to the computer 140 (in the form of a wireless signal transmitted by the communication system 320 of the vehicle 315). The computer 140 may record the acceptance message for executing administrative tasks based on the recorded acceptance message and the previously recorded request message received from the vehicle 115. The administrative tasks can include, for example, setting up a monitoring system to monitor the caravan, arranging for incentive payment, levying a penalty for breaking an agreement, etc.

The computer 140 may relay the acceptance message received from the vehicle 315 to the slipstream driving arrangement system 105 of the vehicle 115. The computer 140 may also provide an instruction to the driver 125 of the vehicle 115 to proceed with forming a caravan with the vehicle 315. The slipstream driving arrangement system 105 of the vehicle 115 may execute the instruction by directing the vehicle computer 110 to rendezvous with the vehicle 315 and move the vehicle 115 into position behind the vehicle 315 in a slipstream arrangement.

The vehicle 115 may rendezvous with the vehicle 315 at a location that is agreed upon based on communications between the drivers of the two vehicles (via a wireless link 330 that supports vehicle-to-vehicle (V2V) communications). In an example scenario, the rendezvous location can be a spot where the vehicle 315 (or the vehicle 115) is stopped or arranged to stop (such as, for example, a rest stop, a gas station, an overnight-stay facility, a motel, or a parking lot).

In another example scenario, neither vehicle may stop, and the rendezvous location can be a spot further down the road 325 that is reached while the vehicle 315 and/or the vehicle 115 are moving. In this case, the vehicle 315 may slow down to allow the vehicle 115 to catch up, and/or the vehicle 115 may increase speed to catch up with the vehicle 315. In some cases, the driver of the vehicle 315 and the driver 125 of the vehicle 115 may agree to rendezvous on a different road (on a detour route, for example).

In a second example embodiment, the slipstream driving arrangement system 105 of the vehicle 115 may communicate directly (device-to-device) with the slipstream driving arrangement system 335 of the vehicle 315 to form a caravan. This arrangement may be advantageous in a situation where the computer 140 is inaccessible to the slipstream driving arrangement system 105 and/or the slipstream driving arrangement system 335. The situation may arise, for example, as a result of an unavailability of the network 150.

Communications between the slipstream driving arrangement system 105 of the vehicle 115 and the slipstream driving arrangement system 335 of the vehicle 315 may be carried out via the wireless link 330. The wireless link 330 may generally support any of various forms of vehicle-to-everything (V2X) communications such as, for example, vehicle-to-vehicle (V2V) communications or vehicle-to-infrastructure (V2I) communications. In this embodiment, the slipstream driving arrangement system 105 of the vehicle 115 may directly negotiate with the slipstream driving arrangement system 335 of the vehicle 315 various conditions and financial arrangements associated with forming a convoy. The computer 140 may, or may not, be involved in the negotiation.

In a third example embodiment, the slipstream driving arrangement system 105 of the vehicle 115 may broadcast a request (in the form of a wireless broadcast signal) to form a caravan. The broadcast can include an offer by the vehicle 115 to operate as a lead vehicle in a slipstream driving arrangement. Any vehicle that receives the request may respond to the request by accepting the offer. The slipstream driving arrangement system 105 may then provide information to the responding vehicle (such as, for example, financial incentives and rendezvous details).

The various procedures described above for forming a caravan are not limited to two vehicles. Similar procedures can be employed to form a caravan of more than two vehicles. As indicated above, an incentive may be provided to a driver of a lead vehicle of the caravan (the vehicle 315 in the illustrated example scenario). The incentive may, for example, be provided in the form of a monetary award.

In an example implementation, the size of the monetary award can be based on factors such as, for example, a size of the lead vehicle (larger the size, larger the slipstream), a speed of movement of the lead vehicle (faster the speed, greater the slipstream), and/or a competitive bidding system.

The competitive bidding system can involve a procedure where each of multiple drivers submits a price offer to operate as a leader of a caravan upon receiving a broadcast request to form a caravan. In an example implementation, the competitive bidding system may be modeled on an auction arrangement where multiple drivers of the other vehicles bid against each other to provide their services.

A driver of a vehicle such as, for example, the driver 125 of the vehicle 115 who may originate the broadcast request can evaluate the price offers and either disregard the price offers or accept one of the price offers. Evaluating the price offers can include, for example, evaluating an amount of an offer, evaluating a type of vehicle making the offer, evaluating a size of the vehicle making the offer, evaluating a speed of the vehicle making the offer, etc.

In a fourth example embodiment, the slipstream driving arrangement system 105 of the vehicle 115 may broadcast a request (in the form of a wireless broadcast signal) to form a caravan. The broadcast can include an offer by the vehicle 115 to operate as a follower vehicle in a slipstream driving arrangement. The slipstream driving arrangement system 105 may also provide information to the responding vehicle (such as, for example, an amount of money that the driver 125 of the vehicle 115 is willing to pay for the slipstream driving arrangement).

One or more drivers who may be willing to operate as a leader of the convoy may evaluate the request and decide to form a caravan as a leader of the caravan. Evaluating the request may involve evaluating various factors such as, for example, a level of inconvenience (detour, speed change, time delay, labor, effort, etc.), costs involved (additional fuel cost, failure to meet delivery schedule, etc.), and other restrictions (driver employment rules, large vehicles are not allowed to travel on some roads, etc.).

The leader of the caravan (in any of various implementations in accordance with the disclosure) may specify one or more conditions associated with fulfilling a leadership role. The conditions can include, for example, a distance over which the leadership role will be provided, a time duration over which the leadership role will be provided, and/or a route over which the leadership role will be provided. Failure to fulfil specified conditions may result in penalties.

In some cases, a first vehicle that is operating as a lead vehicle of a convoy for a first duration of time may rotate out of a lead position and allow a second vehicle to assume the lead position. The first vehicle may rejoin the convoy as a follower vehicle. The remuneration paid to the first vehicle for operating as a lead vehicle can be readjusted to a smaller amount (or no payment) when the first vehicle rotates out of the lead vehicle role and assumes a follower vehicle role. The first vehicle may evaluate the financial incentive offered for operating as the lead vehicle and/or may evaluate a loss incurred as a result of assuming the follower vehicle role, before relinquishing the lead position.

The second vehicle may operate as the lead vehicle of the convoy for a second duration of time and may then relinquish the lead vehicle role to a third vehicle (or back to the first vehicle). The remuneration paid to the second vehicle for operating as a lead vehicle can be a larger amount when the second vehicle rotates out of a follower vehicle role and assumes the lead position. In some situations, the second vehicle that assumes the lead vehicle role may not be a part of the convoy when the first vehicle rotates out of the lead position. In some instances, the leader is rotated amongst the various vehicles of the caravan in order to provide a “net neutral” option for each individual vehicle baring the burden of being the lead vehicle. In this manner, no vehicle may receive a financial incentive to be the lead vehicle.

Financial agreements and transactions between drivers of two or more vehicles may be executed at any of various times such as, for example, prior to forming a caravan, upon forming a caravan, or upon completion of a caravan mode of travel. In one implementation, the computer 140 may manage and administer the financial transactions. Managing a financial transaction can also include penalizing a driver of a vehicle for failure to fulfil a commitment. Thus, for example, a driver of a vehicle that is leader of a caravan may be penalized if a leadership role is not fulfilled as agreed.

Financial transactions may be carried out in various ways including, for example, via payment instruments (such as, for example, Paypal® and Venmo®) available for use via a software application downloaded into a personal communication device of a driver of a vehicle, or via a software module provided in an apparatus in the vehicle (an infotainment system, for example). Payments may also be carried out in other ways such as, for example, bank-to-bank transfers, wire transfers, credits, tokens, and bank deposits/withdrawals. Operations related to credits and/or tokens may be carried out via a software application provided in the personal communication device 120 (for example).

In an example scenario, a processor may execute a software program that evaluates market factors (such as supply and demand) and predicts a price for providing a service (to operate as a lead vehicle of a caravan, for example) and/or for rewarding a rendered service (when a driver fulfils a lead vehicle service. for example).

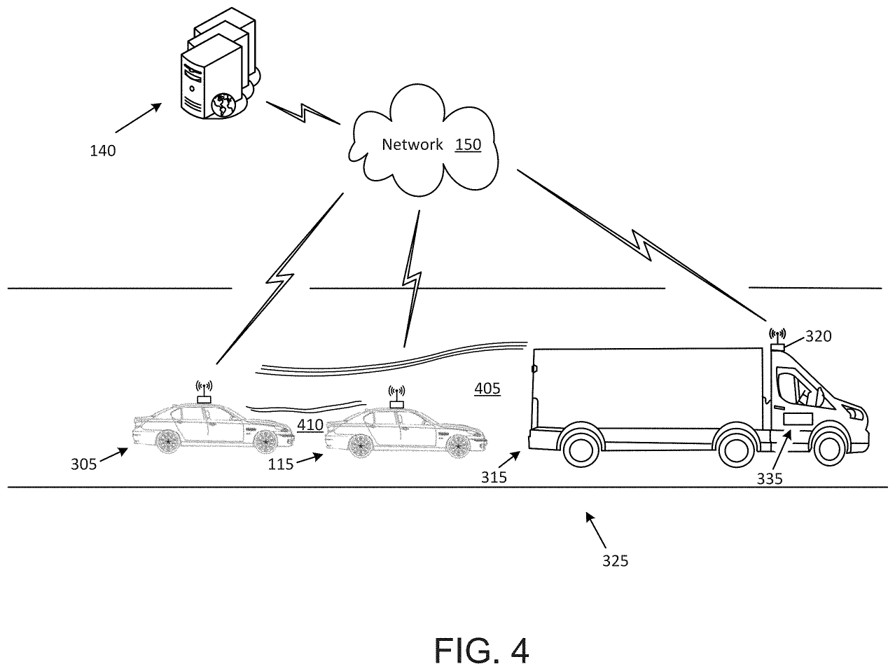

FIG. 4 shows an example scenario involving multiple vehicles moving in a slipstream formation in accordance with the disclosure. The large size and profile of the vehicle 315 creates a significant low-pressure area 405 behind the vehicle 315 as the vehicle 315 moves on the road 325. The vehicle 115 that forms a part of a caravan travels in a manner whereby at least a portion of the vehicle 115 (the front-end, for example) is located in the low-pressure area 405 behind the vehicle 315. Moving in this slipstream travel arrangement provides the driver 125 of the vehicle 115 some benefits, such as reduced fuel consumption and associated cost savings.

Another vehicle 305 may also form a part of the caravan. The size and profile of the vehicle 115 is smaller in comparison to the size and profile of the vehicle 315. Consequently, a low-pressure area 410 that is formed behind the vehicle 115 is smaller than the low-pressure area 405 behind the vehicle 315. The vehicle 315 travels in a manner whereby at least a portion of the vehicle 305 is located in the low-pressure area 410 behind the vehicle 115. Moving in this slipstream travel arrangement provides the driver of the vehicle 305 benefits such as reduced fuel consumption and associated cost savings. However, the smaller size of the low-pressure area 410 in comparison to the low-pressure area 405 may provide a smaller level of benefits to the driver of the vehicle 305 in comparison to benefits derived by the driver 125 of the vehicle 115.

In a first scenario, the driver 125 of the vehicle 115 who is benefitting from the low-pressure area 405 that is formed behind the vehicle 315 may pay a first amount of money to the driver of the vehicle 315. The driver of the vehicle 305 who is benefitting from the low-pressure area 410 that is formed behind the vehicle 115 may pay a second amount of money to the driver 125 of the vehicle 115. The second amount of money can be less than the first amount of money because the low-pressure area 410 behind the vehicle 115 is smaller than the low-pressure area 405 behind the vehicle 315.

In a second scenario, the driver 125 of the vehicle 115 who is benefitting from the low-pressure area 405 that is formed behind the vehicle 315 may pay a first amount of money to the driver of the vehicle 315. The driver of the vehicle 305 who is benefitting from the low-pressure area 410 that is formed behind the vehicle 115 and may also be benefitting to some extent from the low-pressure area 405 that is formed behind the vehicle 315 may pay a second amount of money to the driver 125 of the vehicle 115 and a third amount of money to the driver of the vehicle 315. The second amount of money and the third amount of money can be less than the first amount of money.

In a third scenario, the size and profile of the various vehicles may be different such as, for example, a smaller vehicle may travel in front of a larger vehicle. A driver of the larger vehicle may not derive a level of benefits that can be obtained if the larger vehicle was moving behind an even-larger vehicle rather than the smaller vehicle. Consequently, the driver of the larger vehicle may not pay the driver of the smaller vehicle or may pay a token amount.

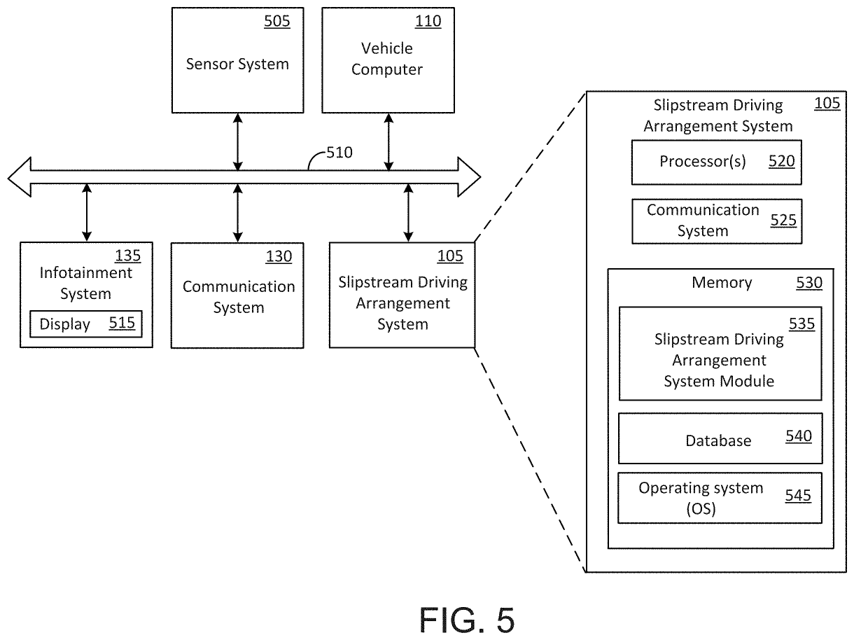

FIG. 5 shows some example components that may be included in the vehicle 115 in accordance with the disclosure. The example components may include the vehicle computer 110, the infotainment system 135, the communication system 130, the slipstream driving arrangement system 105, and a sensor system 505. The various components are communicatively coupled to each other via one or more buses such as an example bus 510. The bus 510 may be implemented using various wired and/or wireless technologies. For example, the bus 510 can be a vehicle bus that uses a controller area network (CAN) bus protocol, a Media Oriented Systems Transport (MOST) bus protocol, and/or a CAN flexible data (CAN-FD) bus protocol. Some or all portions of the bus 510 may also be implemented using wireless technologies such as Bluetooth®, Zigbee®, or near-field-communications (NFC).

The infotainment system 135 can include a display system 515 having a GUI for carrying out various operations. The GUI may be used, for example, by the driver 125 to execute various actions in accordance with the disclosure, such as, for example, to enter a request to form a caravan, to make an offer to operate the vehicle 115 as a lead vehicle (or a follower vehicle), and/or to execute various financial transactions.

In an example implementation, entries made via the GUI are communicated to the slipstream driving arrangement system 105 via the bus 510. In another example implementation, the slipstream driving arrangement system 105 is integrated into the infotainment system 135 which can include a GUI. The infotainment system can include a software module that may be downloaded into the infotainment system 135 (wirelessly or via a wired connection made through a USB port of the infotainment system 135, for example) and executed for performing various operations in accordance with the disclosure.

The sensor system 505 can include various types of sensors such as, for example, a proximity sensor, a distance sensor, and/or a camera. Sensors such as the proximity sensor and the distance sensor may be provided in the form of devices such as, for example, an ultrasonic sensor, a radar sensor, an infrared detector, and/or a light detection and ranging (LIDAR) device. The various sensors may be configured to assist the driver 125 travel in a slipstream travel arrangement. The slipstream travel arrangement involves keeping a safe distance behind a vehicle moving ahead, yet traveling close enough to benefit from a low-pressure area behind the vehicle ahead. An autonomous vehicle can employ similar sensors and/or other types of sensors that are configured to ensure that the autonomous vehicle maintains a safe separation distance behind another vehicle when benefitting from a low-pressure area behind the other vehicle.

The communication system 130 can include various transmitters, receivers, and/or transceivers that allow for wireless communications with components located inside the vehicle 115 (such as, for example, the personal communication device 120) and/or with components located outside the vehicle 115 (such as, for example, the computer 140).

The slipstream driving arrangement system 105 may include a processor 520, a communication system 525, and a memory 530. The communication system 525 can include one or more wireless transceivers that allow the slipstream driving arrangement system 105 to communicate with the communication system 130 for sending out messages from the vehicle 115 and/or for receiving messages in the vehicle 115. The communication system 525 can also include hardware for communicatively coupling the slipstream driving arrangement system 105 to the network 150 for carrying out communications and data transfers with the computer 140.

The memory 530, which is one example of a non-transitory computer-readable medium, may be used to store an operating system (OS) 545, a database 540, and various code modules such as a slipstream driving arrangement system module 535. The code modules are provided in the form of computer-executable instructions that can be executed by the processor 520 for performing various operations in accordance with the disclosure. More particularly, the slipstream driving arrangement system module 535 may be executed by the processor 520 for performing various operations related to forming a caravan and traveling in a slipstream driving arrangement in accordance with disclosure.

In one example implementation, the database 540 may be used to store information such as, for example, cost information associated with forming a caravan and traveling in a slipstream driving arrangement, penalty information, and money-transfer information.

It must be understood that even though the various components in FIG. 2 are shown as discrete functional blocks, some of these components, or some parts of these components, may be combined together in some implementations in accordance with the disclosure. For example, in one example implementation, the slipstream driving arrangement system 105 may be integrated with the vehicle computer 110 (and/or the infotainment system 135) and the processor 520 may be configured to execute operations of the slipstream driving arrangement system 105 as well as the vehicle computer 110 (and/or the infotainment system 135). In another example embodiment, the slipstream driving arrangement system 105 described above with respect to FIG. 5 can be provided in the personal communication device 120 of the driver 125 of the vehicle 115.

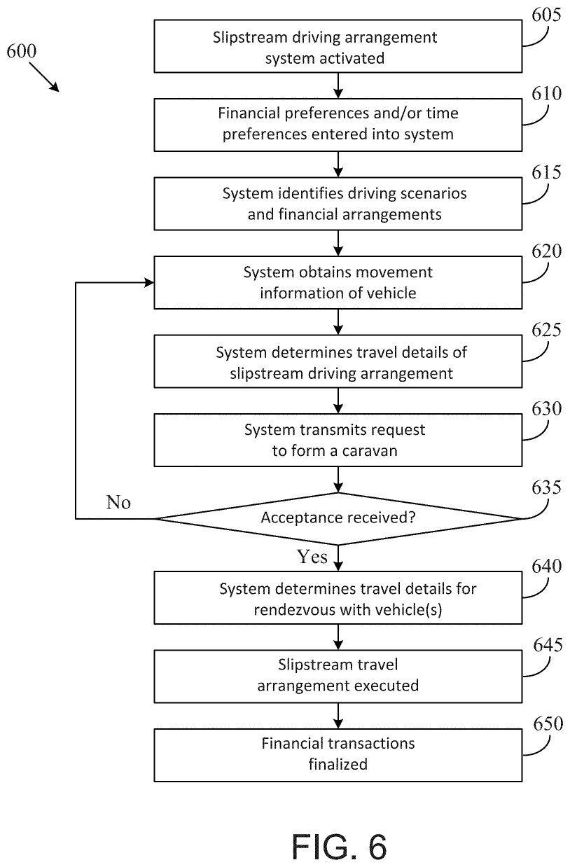

FIG. 6 shows a flowchart 600 of an example method to execute a slipstream driving arrangement in accordance with the disclosure. The flowchart 600 illustrates a sequence of operations that can be implemented in hardware, software, or a combination thereof. In the context of software, the operations represent computer-executable instructions stored on one or more non-transitory computer-readable media such as the memory 530, that, when executed by one or more processors such as the processor 520, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 600 may be carried out by using the slipstream driving arrangement system 105, the infotainment system 135, and the vehicle computer 110. The description below may make reference to certain components and objects shown in FIGS. 1-5, but it should be understood that this is done for purposes of explaining certain aspects of the disclosure and that the description is equally applicable to many other embodiments.

At block 605, the slipstream driving arrangement system 105 is activated. In one example scenario, the driver 125 of the vehicle 115 can activate the slipstream driving arrangement system 105 by turning on the infotainment system 135 and launching a menu on the display system 515 of the infotainment system 135. In another example scenario, the driver 125 of the vehicle 115 can activate the slipstream driving arrangement system 105 by launching a software application on the personal communication device 120. The software application executes the slipstream driving arrangement system 105 in accordance with the disclosure.

At block 610, the driver 125 may use the display system 515 (or a touchscreen of the personal communication device 120) to input information into the slipstream driving arrangement system 105. The information can include, for example, financial preferences and/or time preferences. Financial preferences can include, for example, an amount of money that the driver 125 is willing to accept for performing a leader vehicle role in a caravan, an amount of money that the driver 125 is willing to pay for assuming a follower vehicle role in a caravan, and/or a maximum amount of money that the driver 125 is willing to pay as a penalty for failing to provide a lead vehicle role in a caravan. Timing preferences may include a travel itinerary and travel time constraints. Other information that may be provided may include a preference for a travel route, a maximum acceptable distance for a detour, destination information, intermediate stop locations, preferred rendezvous locations, and/or preferred travel speed.

At block 615, the slipstream driving arrangement system 105 identifies various driving scenarios and/or financial arrangements. The driving scenarios and/or financial arrangements may be associated, for example, with fulfilling a leader vehicle role in a caravan or for operating as a follower vehicle role in a caravan.

At block 620, the slipstream driving arrangement system 105 obtains movement information of the vehicle 115. The movement information can include, for example, a current location of the vehicle 115, a speed of travel of the vehicle 115, a current time (day or night, for example), and timing information (expected time of arrival at a next stop location, for example).

At block 625, the slipstream driving arrangement system 105 determines travel details associated with a slipstream driving arrangement with another vehicle (or vehicles). The determination can include for example, identifying a traffic density on a travel route, availability of other vehicles willing to travel in a slipstream driving arrangement, and travel constraints (speed limit, road characteristics, etc.).

At block 630, the slipstream driving arrangement system 105 transmits a request to form a caravan. The request may be transmitted wirelessly via the communication system 130.

At block 635, the slipstream driving arrangement system 105 makes a determination whether one or more drivers of other vehicles have accepted the request.

If no driver responds to the request, the operations indicated in block 620 and subsequent blocks are executed. On the other hand, if one or more drivers accept the request, at block 640, the slipstream driving arrangement system 105 determines travel details for the vehicle 115 to travel in a slipstream travel arrangement. The travel details can include, for example, identifying a location of the vessel from which the acceptance was received (via V2X communications and/or GPS information, for example), determining a rendezvous location, determining a time for the rendezvous, and/or determining a travel route for the vehicle 115 to the rendezvous location

At block 645, the slipstream driving arrangement system 105 executes the slipstream travel arrangement. The execution can include the slipstream driving arrangement system 105 cooperating with the vehicle computer 110, and/or instructing the driver 125, to control a speed of the vehicle 115 for making a rendezvous (increasing the speed, decreasing the speed, braking, etc.), to travel along a specified travel route (which can include one or more detours, in some cases), and to provide time guidance to the driver 125 (delay, on-time etc.).

At block 650, the slipstream driving arrangement system 105 detects a termination of a slipstream travel arrangement and finalizes financial transactions (determining payments, making payments, receiving payments, etc.)

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device such as the memory 530, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
transmitting, by a first vehicle, a request to form a caravan with a second vehicle;
receiving, by the first vehicle, an acceptance of the request;
executing, by the first vehicle, a rendezvous operation to rendezvous with the second vehicle; and
executing, by the first vehicle, a slipstream formation with the second vehicle.

2. The method of claim 1, wherein the request to caravan with the second vehicle is a vehicle-to-vehicle wireless request.

3. The method of claim 2, wherein executing the rendezvous operation comprises changing a speed of movement of the first vehicle and/or changing a speed of movement of the second vehicle on a road that is shared by the first vehicle and the second vehicle.

4. The method of claim 2, wherein the slipstream formation comprises one of the second vehicle traveling inside a first slipstream generated by the first vehicle or the first vehicle traveling inside a second slipstream generated by the second vehicle.

5. The method of claim 1, wherein the request to form the caravan with the second vehicle is originated by a driver of the first vehicle via a software application in a personal communication device.

6. The method of claim 1, comprising:
evaluating, by one the first vehicle or the second vehicle, a financial incentive for operating as a lead vehicle of the caravan; and
offering, by the one of the first vehicle or the second vehicle, to be the lead vehicle of the caravan for a first duration, based on evaluating the financial incentive.

7. The method of claim 6, further comprising:
detecting, by a server computer, a failure to operate as the lead vehicle for at least a part of the first duration; and
levying, by the server computer, a penalty upon the one of the first vehicle or the second vehicle, based on the failure.

8. A method comprising:
broadcasting, by a first vehicle, an offer to operate as one of a lead vehicle or a follower vehicle in a slipstream driving arrangement;
receiving, by the first vehicle, from a second vehicle, an acceptance of the offer; and
executing, by the first vehicle and the second vehicle, a rendezvous operation to execute a slipstream formation.

9. The method of claim 8, wherein the broadcasting is executed as a vehicle-to-everything (V2X) broadcast.

10. The method of claim 8, wherein executing the rendezvous operation comprises changing a speed of movement of the first vehicle and/or changing a speed of movement of the second vehicle.

11. The method of claim 8, wherein the slipstream formation comprises one of the second vehicle traveling inside a first slipstream generated by the first vehicle or the first vehicle traveling inside a second slipstream generated by the second vehicle.

12. The method of claim 8, wherein the broadcasting is originated by a driver of the first vehicle via a software application in a personal communication device.

13. The method of claim 8, comprising:
evaluating, by one the first vehicle or the second vehicle, a financial incentive for operating as the lead vehicle of a caravan; and
offering, by the one of the first vehicle or the second vehicle, to be the lead vehicle of the caravan for a first duration, based on evaluating the financial incentive.

14. The method of claim 13, further comprising:
detecting, by a server computer, a failure to operate as the lead vehicle for at least a part of the first duration; and
levying, by the server computer, a penalty upon the one of the first vehicle or the second vehicle, based on the failure.

15. A first vehicle comprising:
a vehicle controller;
a communication system; and
a slipstream driving arrangement system comprising:
a memory that stores computer-executable instructions; and
a processor configured to access the memory and execute the computer-executable instructions to at least:
transmit via the communication system, a request to form a caravan with a second vehicle;
receive via the communication system, an acceptance of the request;
cooperate with the vehicle controller to execute a rendezvous operation to rendezvous with the second vehicle; and
cooperate with the vehicle controller to execute a slipstream formation with the second vehicle.

16. The first vehicle of claim 15, wherein the slipstream driving arrangement system is a part of an infotainment system in the first vehicle and/or a personal communication device of a driver of the first vehicle.

17. The first vehicle of claim 15, wherein the processor is further configured to access the memory and execute computer-executable instructions to perform additional operations comprising:
evaluate a financial incentive for operating as a lead vehicle of the caravan; and
offer to be the lead vehicle of the caravan for a first duration, based on evaluating the financial incentive.

18. The first vehicle of claim 15, wherein the processor is further configured to access the memory and execute computer-executable instructions to perform additional operations comprising:
evaluate a financial incentive for operating as a lead vehicle of the caravan; and
offer to be the lead vehicle of the caravan for a first duration, based on evaluating the financial incentive.

19. The first vehicle of claim 18, wherein the processor is further configured to access the memory and execute computer-executable instructions to perform additional operations comprising:
offer to be a follower vehicle of the caravan for a second duration, based on evaluating the financial incentive.

20. The first vehicle of claim 18, wherein cooperating with the vehicle controller to execute the rendezvous operation comprises changing a speed of movement of the first vehicle on a road in which the second vehicle is moving.
